(19) United States
(12) Patent Application Publication
(10) Pub. No.: US 2026/0124108 A1
(43) Pub. Date: May 7, 2026

(54) MASSAGE HEAD STRUCTURE AND VIBRATION MASSAGER

(71) Applicant: ZheJiang E-cozy Electronic Technology Co., Ltd., Wenzhou (CN)

(72) Inventors: Shousheng TANG, Wenzhou (CN); Daojin TANG, Wenzhou (CN); Jianshou CHEN, Wenzhou (CN)

(21) Appl. No.: 19/009,739

(22) Filed: Jan. 3, 2025

(30) Foreign Application Priority Data
Nov. 6, 2024 (CN) 202422699472.2

(51) Int. Cl. A61H 23/02

(52) U.S. Cl. CPC A61H 23/0254; A61H 2201/0153; A61H 2201/0207; A61H 2201/0214; A61H 2201/025; A61H 2201/10

(57) ABSTRACT

A massage head structure and a vibration massager are provided and relate to the technical field of massagers. The technical problem that a massager in the prior art has a single function, which affects the user experience. The massage head structure and vibration massager includes a massage head main body and a power supplying control assembly; a vibration assembly is arranged in the massage head main body; the massage head main body is provided with a first massage portion; both the vibration assembly and the first massage portion are electrically connected to the power supplying control assembly; the first massage portion includes a cold and hot head and a cooling and heating assembly; the cooling and heating assembly is connected to the cold and hot head; and the power supplying control assembly is configured to drive the cooling and heating assembly to preform cooling or heating, so that heat is transferred to the cold and hot head. The massage head structure and the vibration massager which have richer functions and enhance the user experience are provided.

### TECHNICAL FIELD

The present disclosure relates to the technical field of massagers, and in particular, to a massage head structure and a vibration massager.

### BACKGROUND

Massage has many benefits. For example, massage can be used to promote blood circulation, relieve pain, and dredge meridians. Massage can be used to adjust functions, regulate Yin and Yang, eliminate fatigue, and relieve stress.

At present, massage sticks are used for auxiliary massaging during massage therapy. However, most of the existing massage sticks have a single massage effect and only have an ability of pushing the skin of a user for treatment. These massage sticks cannot achieve heat or cold compress while massaging the body of a user. As a result, the massage sticks have a poor massage effect and affect the user experience.

### SUMMARY

The present disclosure aims to provide a massage head structure and a vibration massager, to solve the technical problem that a massager in the prior art has a single function, which affects the user experience. Many technical effects achieved by optional technical solutions of many technical solutions of the present disclosure are described in detail below.

To achieve the above objectives, the present disclosure provides the following technical solutions:
In an aspect, the present disclosure provides a massage head structure, including a massage head main body and a power supplying control assembly.

Where:
a vibration assembly is arranged in the massage head main body; a first massage portion is arranged on the massage head main body; both the vibration assembly and the first massage portion are electrically connected to the power supplying control assembly;
the first massage portion comprises a cold and hot head and a cooling and heating assembly; the cooling and heating assembly is connected to the cold and hot head; and the power supplying control assembly is configured to drive the cooling and heating assembly to preform cooling or heating, so that heat is transferred to the cold and hot head.

Optionally, the cooling and heating assembly includes a cooling sheet, a heat dissipation sheet, and a heat dissipation fan; the cooling sheet is connected to the cold and hot head; the heat dissipation sheet is arranged on one side of the cooling sheet away from the cold and hot head; and the heat dissipation fan is arranged on one side of the heat dissipation sheet away from the cooling sheet.

Optionally, an air inlet structure is arranged at a position, corresponding to the heat dissipation sheet, on the massage head main body; an air outlet of the heat dissipation fan is oriented towards an inside of the massage head main body;
an air outlet structure is further arranged on the massage head main body; a heat dissipation channel is formed between the vibration assembly and the massage head main body; and the heat dissipation channel communicates the air inlet structure with the air outlet structure.

Optionally, the massage head main body includes a massage shell and a first shell; the first shell is connected to the massage shell; the vibration assembly is arranged in the massage shell; and the first massage portion is arranged in the first shell.

Optionally, the vibration assembly includes a vibration motor; output shafts are arranged at two ends of the vibration motor; the output shafts at the two ends of the vibration motor are connected to the massage shell through bearings; silica gel bearing sleeves are arranged between the bearings and the massage shell; and eccentric blocks are arranged on the output shafts at the two ends of the vibration motor.

Optionally, a second shell is further arranged on the massage shell; an infrared lamp panel is arranged in the second shell; the infrared lamp panel is electrically connected to the power supplying control assembly; an infrared lampshade is arranged on the second shell;
the massage shell is further provided with a third shell; and the third shell is provided with a cylindrical massage head.

Optionally, the first shell, the second shell, and the third shell are spaced apart respectively in a circumferential direction of the massage shell.

In another aspect, the present disclosure provides a vibration massager, including any of the above massage head structures.

Preferably, the vibration massager further includes a massage handle. The power supplying control assembly is arranged in the massage handle; the massage head structure is arranged at a first end of the massage handle; and a flexible connection structure is arranged between the massage head structure and the massage handle.

Preferably, the flexible connection structure includes vibration silica gel and a vibration connection head; the vibration connection head is connected to the massage handle; and the vibration silica gel is connected between the vibration connection head and the massage head main body.

The massage head structure and the vibration massager have the beneficial effects: The massage head structure and the vibration massager according to the present disclosure include a massage head main body and a power supplying control assembly. A vibration assembly is arranged in the massage head main body. The vibration assembly is configured to drive the massage head main body to vibrate, so as to massage different uncomfortable parts of a body, and a massage therapy function is achieved. The massage head main body is provided with a first massage portion. Both the vibration assembly and the first massage portion are electrically connected to the power supplying control assembly. The first massage portion includes a cold and hot head and a cooling and heating assembly. The cooling and heating assembly is connected to the cold and hot head. The power supplying control assembly is configured to drive the cooling and heating assembly to preform cooling or heating, so that heat is transferred to the cold and hot head. Heat or cold compress is applied to the body through the cold and hot head, and demands of muscles for cold and heat are met. Thus, the massage head structure according to the present disclosure can have a heat compress function and a cold compress function, so that the function of the massage head structure, the massage effect, and the user experience are enhanced.

### BRIEF DESCRIPTION OF THE DRAWINGS

To describe the technical solutions in the embodiments of the present disclosure or in the prior art more clearly, the following briefly introduces the accompanying drawings for describing the embodiments or the related art. Apparently, the accompanying drawings in the following description show merely some embodiments of the present disclosure, and a person of ordinary skill in the art may still derive other drawings according to these accompanying drawings without creative efforts.

FIG. 1 is a three-dimensional diagram of a vibration massager according to the present disclosure;

FIG. 2 is a three-dimensional diagram of a detachable silica gel decorating part of a vibration massager according to the present disclosure;

FIG. 3 is a three-dimensional diagram of a detachable silica gel decorating part and vibration silica gel according to the present disclosure;

FIG. 4 is a schematic diagram (I) of an internal structure of a massage head structure of a vibration massager according to the present disclosure;

FIG. 5 is a schematic diagram (II) of an internal structure of a massage head structure of a vibration massager according to the present disclosure; and

FIG. 6 is an exploded diagram of a vibration massager according to the present disclosure.

In the drawings:
100: massage head structure; 200: massage handle; 300: flexible connection structure;
110: massage head main body; 120: vibration assembly; 130: first massage portion; 140: power supplying control assembly;
111: massage shell; 112: first shell; 113: second shell; 114: third shell; 115: air outlet structure; 116: heat dissipation channel; 117: infrared lamp panel; 118: infrared lampshade; 119: cylindrical massage head; 1111: silica gel head part;
121: vibration motor; 122: output shaft; 123: bearing; 124: eccentric block; 125: silica gel bearing sleeve;
131: cold and hot head; 132: cooling sheet; 133: heat dissipation sheet; 134: heat dissipation fan; 135: air inlet structure; 136: heat conduction film; 137: fan bracket;
141: battery pack; 142: driving plate; 143: button assembly; 144: temperature control assembly; 145: start assembly;
210: silica gel handle sleeve;
310: vibration silica gel; 320: vibration connection head; 330: silica gel decorating part; 340: nut; 350: through hole; and 360: connector.

### DETAILED DESCRIPTION OF THE EMBODIMENTS

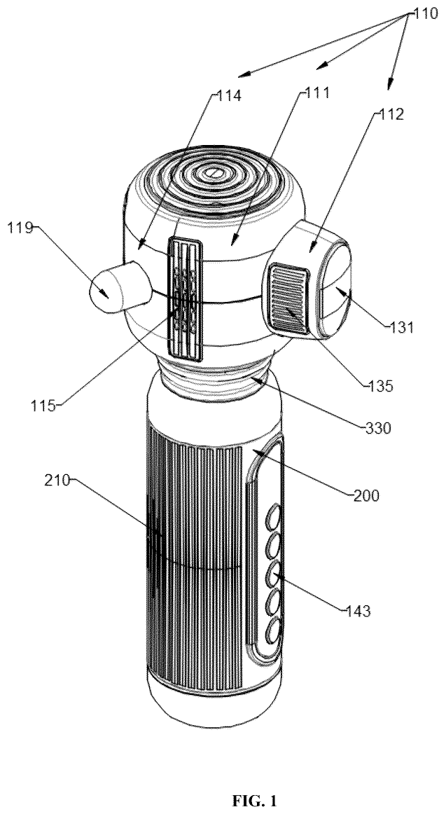

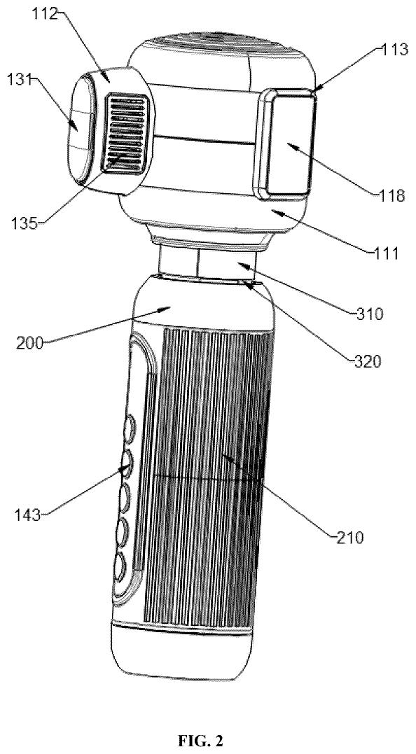

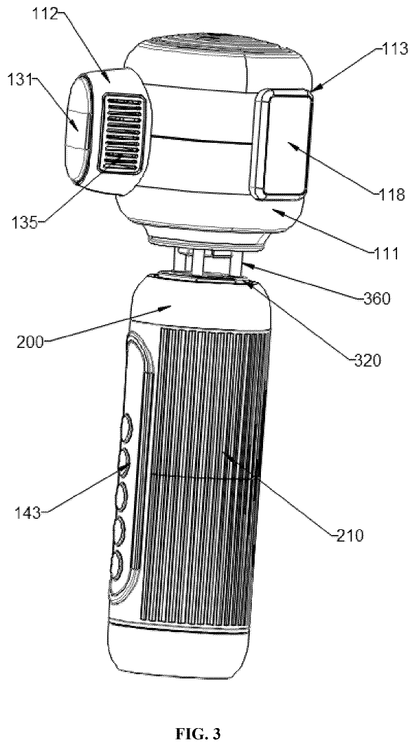

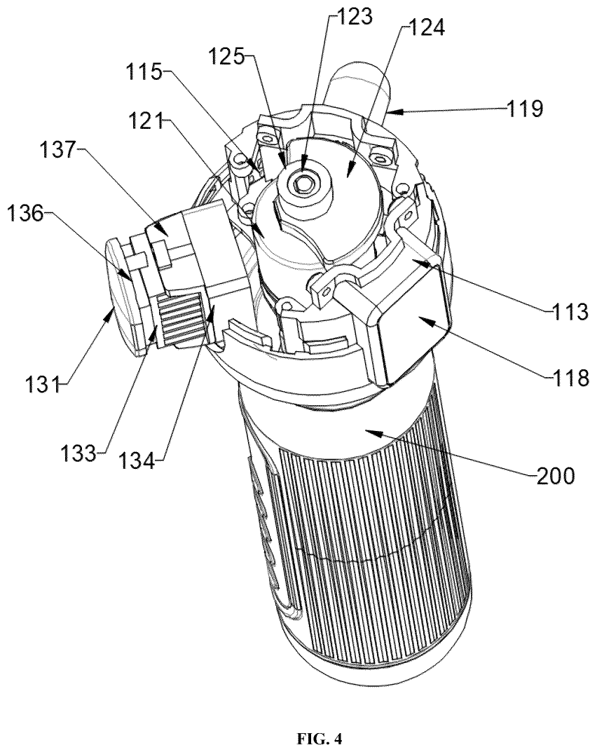

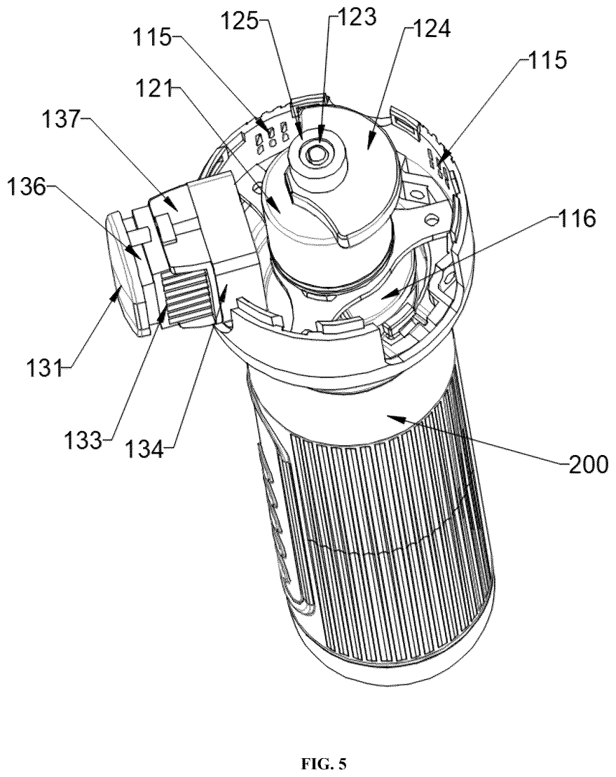

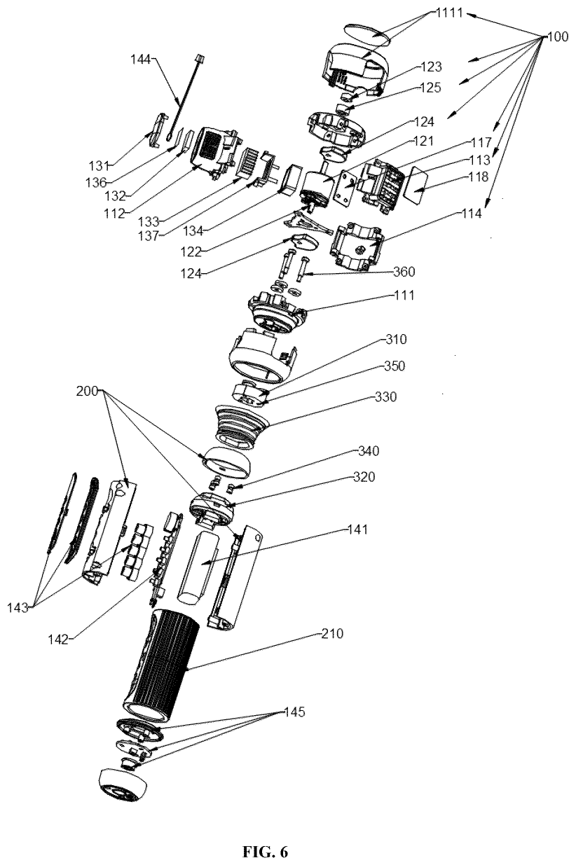

The content of the present disclosure and differences between the present disclosure and the prior art can be understood with reference to FIG. 1 to FIG. 6 and literal content below. The following provides a further detailed description for the technical solutions (including preferred technical solutions) of the present disclosure through accompanying drawings and by listing some optional embodiments of the present disclosure. It should be noted that any technical feature or any technical solution in this embodiment is one or more of many optional technical features or optional technical solutions. For the sake of simplicity, this document cannot exhaustively list all alternative technical features and alternative technical solutions of the present disclosure, and is not convenient to emphasize that an implementation of each technical feature is one of the multiple optional implementations. Therefore, those skilled in the art should know that any technical means provided by the present disclosure can be replaced or any two or more technical means or technical features provided by the present disclosure can be combined with each other to obtain a new technical solution. Any technical features or any technical solutions in this embodiment do not limit the scope of protection of the present disclosure. The scope of protection of the present disclosure should include any alternative technical solutions that can be conceived by those skilled in the art without creative labor, and new technical solutions obtained by combining, by those skilled the art, any two or more technical means or technical features provided by the present disclosure.

In the description of the present disclosure, it should be noted that unless otherwise stated, “plurality” means two or more. Orientations or positional relationships indicated by the terms “upper”, “lower”, “left”, “right”, “inside”, “outside”, “front end”, “rear end”, “head part”, “tail part” and the like are orientations or positional relationships as shown in the drawings, and are only for the purpose of facilitating and simplifying the description of the present disclosure instead of indicating or implying that devices or elements indicated must have particular orientations, and be constructed and operated in the particular orientations, so that these terms are not construed as limiting the present disclosure. In addition, the terms “first”, “second”, “third”, and the like are only for the purpose of description, and may not be understood as indicating or implying the relative importance.

In the description of the present disclosure, it should also be noted that unless otherwise specified and limited, the terms “mount”, “connect”, and “connection” should be broadly understood. For example, it can be a fixed connection, detachable connection, integrated connection, mechanical connection, electrical connection, direct connection, or indirect connection via an intermediate element. For those of ordinary skill in the art, the specific meanings of the aforementioned terms in the present disclosure can be understood according to specific conditions.

The present disclosure provides a massage head structure and a vibration massager which have richer functions and enhance the user experience.

The technical solutions according to the present disclosure will be explained below in more details in conjunction with FIG. 1 to FIG. 6.

The present disclosure provides a massage head structure 100, including a massage head main body 110 and a power supplying control assembly 140.

A vibration assembly 120 is arranged in the massage head main body 110. A first massage portion 130 is arranged on the massage head main body 110. Both the vibration assembly 120 and the first massage portion 130 are electrically connected to the power supplying control assembly 140.

The first massage portion 130 includes a cold and hot head 131 and a cooling and heating assembly. The cooling and heating assembly is connected to the cold and hot head 131. The power supplying control assembly 140 is configured to drive the cooling and heating assembly to preform cooling or heating, so that heat is transferred to the cold and hot head 131.

The massage head structure 100 according to the present disclosure includes a massage head main body 110 and a power supplying control assembly 140. A vibration assembly 120 is arranged in the massage head main body 110. The vibration assembly 120 is configured to drive the massage head main body 110 to vibrate, so as to massage different uncomfortable parts of a body, and a massage therapy function is achieved. The massage head main body 110 is provided with a first massage portion 130. Both the vibration assembly 120 and the first massage portion 130 are electrically connected to the power supplying control assembly 140. The first massage portion 130 includes a cold and hot head 131 and a cooling and heating assembly. The cooling and heating assembly is connected to the cold and hot head 131. The power supplying control assembly 140 is configured to drive the cooling and heating assembly to preform cooling or heating, so that heat is transferred to the cold and hot head 131. Heat or cold compress is applied to the body through the cold and hot head 131, and demands of muscles for cold and heat are met. Thus, the massage head structure 100 according to the present disclosure can have a heat compress function and a cold compress function, so that the function of the massage head structure 100, the massage effect, and the user experience are enhanced.

It should be noted that one or two or more groups of the first massage portions 130 can be provided. When two or more groups of the first massage portions 130 are provided, set temperatures of the first massage portions 130 can be the same or different, and the temperatures of the first massage portions 130 can be adjusted according to an actual need. Since temperature adjustment is a function that can be achieved in the prior art, it will not be elaborated here.

It can be understood that the massage head main body 110 is provided with a silica gel massage head sleeve. The silica gel massage head sleeve is configured to improve the comfort level of a user and provide a better user experience. The massage head main body 110 can be assembled from two or more parts using detachable structures according to an actual need. Specific forms of the detachable structures will not be elaborated here.

In some embodiments of the present disclosure, the cooling and heating assembly includes a cooling sheet 132, a heat dissipation sheet 133, and a heat dissipation fan 134. The cooling sheet 132 is connected to the cold and hot head 131. The heat dissipation sheet 133 is arranged on one side of the cooling sheet 132 away from the cold and hot head 131. The heat dissipation fan 134 is arranged on one side of the heat dissipation sheet 133 away from the cooling sheet 132.

In some embodiments of the present disclosure, the cooling and heating assembly includes the cooling sheet 132. The cooling sheet 132 is configured to achieve heating or cooling. The heat dissipation sheet 133 and the heat dissipation fan 134 are configured to dissipate heat when the cooling sheet 132 achieves cooling, to enhance the cooling effect.

In some embodiments of the present disclosure, an air inlet structure 135 is arranged at a position, corresponding to the heat dissipation sheet 133, on the massage head main body 110. An air outlet of the heat dissipation fan 134 is oriented towards an inside of the massage head main body 110.

An air outlet structure 115 is further arranged on the massage head main body 110. A heat dissipation channel 116 is formed between the vibration assembly 120 and the massage head main body 110. The heat dissipation channel 116 communicates the air inlet structure 135 with the air outlet structure 115.

In some embodiments of the present disclosure, the air inlet structure 135 and the air outlet structure 115 are arranged on the massage head main body 110, and the air inlet structure 135 is arranged at the position corresponding to the heat dissipation sheet 133. Since the heat dissipation channel 116 is formed between the vibration assembly 120 and the massage head main body 110. The heat dissipation channel 116 communicates the air inlet structure 135 with the air outlet structure 115. The heat dissipation sheet 133 and the heat dissipation fan 134 can take away heat generated by the cooling sheet 132 during cooling, thereby ensuring a better cooling effect. Furthermore, the cooling fan 134 can further dissipate heat from components inside the massage head main body 110 during operation.

It should be noted that the air inlet structure 135 and the air outlet structure 115 are ventilation grille structures. Of course, the air inlet structure 135 and the air outlet structure 115 may directly adopt a structure with several circular holes arrayed.

In some embodiments of the present disclosure, the massage head main body 110 includes a massage shell 111 and a first shell 112. The first shell 112 is connected to the massage shell 111. The vibration assembly 120 is arranged in the massage shell 111. The first massage portion 130 is arranged in the first shell 112.

In some embodiments of the present disclosure, the massage head main body 110 includes the massage shell 111 and the first shell 112. The first shell 112 is connected to the massage shell 111. The vibration assembly 120 is arranged in the massage shell 111. The vibration assembly 120 can drive the massage shell 111 and the first shell 112 to vibrate. The first massage portion 130 is arranged in the first shell 112, so that a body can be massaged by vibration through the first massage portion 130, or a heat compress or a cold compress is applied to a body through the cold and hot head 131, which meets a demand of the muscles for cold and heat.

In some embodiments of the present disclosure, the vibration assembly 120 includes a vibration motor 121. Output shafts 122 are arranged at two ends of the vibration motor 121. The output shafts 122 at the two ends of the vibration motor 121 are connected to the massage shell 111 through bearings 123. Silica gel bearing sleeves 125 are arranged between the bearings 123 and the massage shell 111. Eccentric blocks 124 are arranged on the output shafts 122 at the two ends of the vibration motor 121.

In some embodiments of the present disclosure, the eccentric blocks 124 are arranged on the two output shafts 122 of the vibration motor 121, and the eccentric blocks 124 can vibrate under the driving of the vibration motor 121. The two output shafts 122 of the vibration motor 121 are connected to the massage shell 111 through the bearings 123, thereby ensuring that the vibration motor 121 can be located in the massage shell 111, to effectively protect the vibration motor 121, ensure that the massage head structure 100 operates more stably, effectively protect the motor, and ensure a better user experience. The silica gel bearing sleeves 125 can achieve a vibration attenuation effect and effectively protect the massage shell 111.

In some embodiments of the present disclosure, a second shell 113 is further arranged on the massage shell 111. An infrared lamp panel 117 is arranged in the second shell 113. An infrared lampshade 118 is arranged on the second shell 113.

The massage shell 111 is further provided with a third shell 114. The third shell 114 is provided with a cylindrical massage head 119.

In some embodiments of the present disclosure, the second shell 113 is further arranged on the massage shell 111, and the infrared lamp panel 117 and the infrared lampshade 118 are arranged in the second shell 113, thereby ensuring that the massage shell 111 has an infrared therapy function and further adding the infrared therapy function to the massage head structure 100. The massage shell 111 is further provided with a third shell 114. The third shell 114 is provided with the cylindrical massage head 119. The cylindrical massage head 119 can provide a user with different massage needs.

It can be understood that the cylindrical massage head 119 can be other massage heads with a massage function, to ensure that the massage head structure 100 according to the present disclosure has different massage functions and effects, so as to meet usage needs of different people and different massage positions.

In some embodiments of the present disclosure, the first shell 112, the second shell 113, and the third shell 114 are spaced apart respectively in a circumferential direction of the massage shell 111.

In some embodiments of the present disclosure, the first shell 112, the second shell 113, and the third shell 114 are spaced apart respectively in the circumferential direction of the massage shell 111. A user can rotate and change the massage head to meet massage needs of different positions. It is convenient to change the massage head.

The present disclosure further provides a vibration massager, including the above massage head structure 100.

In some embodiments of the present disclosure, the vibration massager further includes a massage handle 200. The power supplying control assembly 140 is arranged in the massage handle 200. The massage head structure 100 is arranged at a first end of the massage handle 200. A flexible connection structure 300 is arranged between the massage head structure 100 and the massage handle 200.

In some embodiments of the present disclosure, the vibration massager further includes the massage handle 200, and the flexible connection structure 300 is arranged between the massage head structure 100 and the massage handle 200. When the massage handle 200 is held, under the action of the flexible connection structure 300, the massage head structure 100 can vibrate for massaging, which can effectively reduce hand vibration, thereby enhancing a feeling of holding of a user and improving the quality of use.

In some embodiments of the present disclosure, the flexible connection structure 300 includes vibration silica gel 310 and a vibration connection head 320. The vibration connection head 320 is connected to the massage handle 200. The vibration silica gel 310 is connected between the vibration connection head 320 and the massage head main body 110.

In some embodiments of the present disclosure, the flexible connection structure 300 includes the vibration silica gel 310 and the vibration connection head 320. The vibration connection head 320 is connected to the massage handle 200. The vibration silica gel 310 is connected between the vibration connection head 320 and the massage head main body 110, thereby achieving connection between the massage handle 200 and the massage head main body 110, which ensures that the vibration of the massage handle 200 can be reduced and the user experience can be enhanced.

In some embodiments of the present disclosure, the vibration connection head 320 is provided with several nuts 340. The several nuts 340 are embedded in the vibration connection head 320. Several through holes 350 are provided in the vibration silica gel 310, and several connectors 360 are connected to the several nuts 340 through the through holes 350, thereby connecting the vibration connection head 320, the vibration silica gel 310, and the massage head main body 110. When the vibration assembly 120 operates, the vibration silica gel 310 plays a buffering role, and the vibration silica gel 310 does not affect the vibration of the massage head main body 110.

It can be understood that the vibration silica gel 310 is made of silica gel, or of course, may be made of rubber or another elastic or flexible material.

### Embodiment 1

A vibration massager according to the present disclosure includes a massage handle 200 and a massage head structure 100.

The massage head structure 100 includes a massage head main body 110 and a power supplying control assembly 140. A vibration assembly 120 is arranged in the massage head main body 110. A first massage portion 130 is arranged on the massage head main body 110. Both the vibration assembly 120 and the first massage portion 130 are electrically connected to the power supplying control assembly 140.

The power supplying control assembly 140 is arranged in the massage handle 200. A silica gel handle sleeve 210 is arranged on the massage handle 200. The massage head structure 100 is arranged at a first end of the massage handle 200. A flexible connection structure 300 is arranged between the massage head structure 100 and the massage handle 200.

Specifically, the flexible connection structure 300 includes vibration silica gel 310 and a vibration connection head 320. The vibration connection head 320 is connected to the massage handle 200. The vibration silica gel 310 is connected between the vibration connection head 320 and the massage head main body 110.

More particularly, the vibration connection head 320 is provided with three nuts 340. The three nuts 340 are embedded in the vibration connection head 320. Three through holes 350 are provided in the vibration silica gel 310, and the three connectors 360 are connected to the three nuts 340 through the through holes 350, thereby connecting the vibration connection head 320, the vibration silica gel 310, and the massage head main body 110.

Optionally, a silica gel decorating part 330 is arranged between the massage handle 200 and the massage head structure 100.

Further, the massage head main body 110 includes a massage shell 111, a first shell 112, a second shell 113, and a third shell 114. The first shell 112, the second shell 113, and the third shell 114 are spaced apart respectively along a circumferential direction of the massage shell 111, and a silica gel head part 1111 is arranged at a top of the massage shell 111.

The vibration assembly 120 is arranged in the massage shell 111. The first massage portion 130 is arranged in the first shell 112. An infrared lamp panel 117 is arranged in the second shell 113, and the second shell 113 is provided with an infrared lampshade 118. A cylindrical massage head 119 is arranged on the third shell 114.

The vibration assembly 120 includes a vibration motor 121. Output shafts 122 are arranged at two ends of the vibration motor 121. The output shafts 122 at the two ends of the vibration motor 121 are connected to the massage shell 111 through bearings 123. Furthermore, silica gel bearing sleeves 125 are arranged between the bearings 123 and the massage shell 111. Eccentric blocks 124 are arranged on the output shafts 122 at the two ends of the vibration motor 121.

Further, the first massage portion 130 includes a cold and hot head 131 and a cooling and heating assembly. The cooling and heating assembly is connected to the cold and hot head 131. The power supplying control assembly 140 is configured to drive the cooling and heating assembly to preform cooling or heating, so that heat is transferred to the cold and hot head 131.

Specifically, the cooling and heating assembly includes a cooling sheet 132, a heat dissipation sheet 133, and a heat dissipation fan 134. The cooling sheet 132 is connected to the cold and hot head 131 through a heat conduction film. The heat dissipation sheet 133 is arranged on one side of the cooling sheet 132 away from the cold and hot head 131. The heat dissipation fan 134 is arranged on one side of the heat dissipation sheet 133 away from the cooling sheet 132. The heat dissipation fan 134 is fixed by a fan bracket.

Still further, an air inlet structure 135 is arranged at a position, corresponding to the heat dissipation sheet 133, on the first shell 112. An air outlet of the heat dissipation fan 134 is oriented towards an inside of the massage head main body 110.

An air outlet structure 115 is further arranged on the massage shell 111. A heat dissipation channel 116 is formed between the vibration assembly 120 and the massage head main body 111. The heat dissipation channel 116 communicates the air inlet structure 135 with the air outlet structure 115.

Further, the power supplying control assembly 140 includes a battery pack 141, a driving plate 142, a button assembly 143, a temperature control assembly 144, and a start assembly 145. The driving plate 142 is electrically connected to the battery pack 141, and the infrared lamp panel 117, the vibration motor 121, the cooling sheet 132, the heat dissipation fan 134, the temperature control assembly 144, and the start assembly 145 are all electrically connected to the driving plate 142.

Specifically, the temperature control assembly 144 is a thermistor.

In description of this specification, description of reference terms such as “example”, “embodiment”, or “some embodiments” means that specific features, structures, materials, or characteristics described in the embodiment or example are included at least embodiment or example of the present disclosure. In this specification, the schematic representations of the above terms are not necessarily intended to refer to the same embodiment or example. Furthermore, the specific features, structures, materials or characteristics described may be combined in any suitable manner in any one or more embodiments or examples.

The creation of the present disclosure is not limited to the above implementations. Those skilled in the art can also make various equivalent transformations or replacements without departing from the spirit of the present disclosure. These equivalent transformations or replacements shall all fall within the scope of the claims of the present disclosure.

What is claimed is:

1. A massage head structure, comprising a massage head main body and a power supplying control assembly,
wherein
a vibration assembly is arranged in the massage head main body; a first massage portion is arranged on the massage head main body; both the vibration assembly and the first massage portion are electrically connected to the power supplying control assembly;
the first massage portion comprises a cold and hot head and a cooling and heating assembly; the cooling and heating assembly is connected to the cold and hot head; and the power supplying control assembly is configured to drive the cooling and heating assembly to preform cooling or heating, so that heat is transferred to the cold and hot head.

2. The massage head structure according to claim 1, wherein the cooling and heating assembly comprises a cooling sheet, a heat dissipation sheet, and a heat dissipation fan; the cooling sheet is connected to the cold and hot head; the heat dissipation sheet is arranged on one side of the cooling sheet away from the cold and hot head; and the heat dissipation fan is arranged on one side of the heat dissipation sheet away from the cooling sheet.

3. The massage head structure according to claim 2, wherein an air inlet structure is arranged at a position, corresponding to the heat dissipation sheet, on the massage head main body; an air outlet of the heat dissipation fan is oriented towards an inside of the massage head main body;
an air outlet structure is further arranged on the massage head main body; a heat dissipation channel is formed between the vibration assembly and the massage head main body; and the heat dissipation channel communicates the air inlet structure with the air outlet structure.

4. The massage head structure according to claim 2, wherein the massage head main body comprises a massage shell and a first shell; the first shell is connected to the massage shell; the vibration assembly is arranged in the massage shell; and the first massage portion is arranged in the first shell.

5. The massage head structure according to claim 4, wherein the vibration assembly comprises a vibration motor; output shafts are arranged at two ends of the vibration motor; the output shafts at the two ends of the vibration motor are connected to the massage shell through bearings; silica gel bearing sleeves are arranged between the bearings and the massage shell; and eccentric blocks are arranged on the output shafts at the two ends of the vibration motor.

6. The massage head structure according to claim 4, wherein a second shell is further arranged on the massage shell; an infrared lamp panel is arranged in the second shell; the infrared lamp panel is electrically connected to the power supplying control assembly; an infrared lampshade is arranged on the second shell;
the massage shell is further provided with a third shell; and the third shell is provided with a cylindrical massage head.

7. The massage head structure according to claim 6, wherein the first shell, the second shell, and the third shell are spaced apart respectively in a circumferential direction of the massage shell.

8. A vibration massager, comprising the massage head structure according to claim 1.

9. The vibration massager according to claim 8, further comprising a massage handle, wherein the power supplying control assembly is arranged in the massage handle; the massage head structure is arranged at a first end of the massage handle; and a flexible connection structure is arranged between the massage head structure and the massage handle.

10. The vibration massager according to claim 9, wherein the flexible connection structure comprises vibration silica gel and a vibration connection head; the vibration connection head is connected to the massage handle; and the vibration silica gel is connected between the vibration connection head and the massage head main body.
